(19) United States
(12) Patent Application Publication
(10) Pub. No.: US 2021/0257630 A1
(43) Pub. Date: Aug. 19, 2021

(54) METHODS OF FORMULATING POROUS ELECTRODES USING PHASE INVERSION, AND RESULTING DEVICES FROM THE SAME

(71) Applicants: Massachusetts Institute of Technology, Cambridge, MA (US); Eindhoven University of Technology, Eindhoven (NL)

(72) Inventors: Antoni Forner-Cuenca, Eindhoven (NL); Charles Tai-Chieh Wan, Cambridge, MA (US); Remy Richard Jacquemond, Eindhoven (NL); Fikile Richard Brushett, Cambridge, MA (US)

(21) Appl. No.: 17/176,796

(22) Filed: Feb. 16, 2021

Related U.S. Application Data
(60) Provisional application No. 63/071,595, filed on Aug. 28, 2020.
(60) Provisional application No. 62/976,601, filed on Feb. 14, 2020.

(51) Int. Cl. H01M 4/96; H01M 4/88; H01M 8/18; C01B 32/05

(52) U.S. Cl. CPC H01M 4/96; H01M 4/8817; H01M 8/188; C01P 2006/40; C01B 32/05; C01P 2004/03; H01M 4/8875

(57) ABSTRACT

Methods of forming porous electrodes are provided, such porous electrodes, and thus the techniques for forming the same, having beneficial uses in conjunction with redox flow batteries. The methods include the use of phase inversion as part of the fabrication process. In one exemplary embodiment, a polymer solution is immersed in one solvent in conjunction with performing polymer blend casting, and then is subsequently immersed in a second solvent to induce phase inversion. The phase inversion causes two polymers from the polymer solution to separate, leaving one polymer as a standalone porous polymer and the other polymer with the two solvents in which the polymer solution was disposed. Post-treatments can be performed on the porous polymer to form a desired porous electrode configuration. The electrode can be used in a redox flow battery, for example. Various formulation techniques and recipes, along with resulting porous electrode configurations, are also provided.

### CROSS REFERENCE TO RELATED APPLICATIONS

The present application claims priority to and the benefit of U.S. Provisional Patent Application No. 62/976,601, filed Feb. 14, 2020, and titled “Methods of Formulating Porous Electrodes Using Phase Inversion, and Resulting Devices from the Same,” and U.S. Provisional Patent Application No. 63/071,595, filed Aug. 28, 2020, and titled “Methods of Formulating Porous Electrodes Using Phase Inversion, and Resulting Devices from the Same,” the contents of which are incorporated herein by reference in their entireties.

### GOVERNMENT RIGHTS

This invention was made with Government support under Grant No. DE-AC02-06CH11357 awarded by the Department of Energy. The Government has certain rights in the invention.

### FIELD

The present disclosure relates to methods and techniques for fabricating porous electrodes, and more particularly relates to utilizing phase inversion techniques during fabrication. The porous electrodes can be used, for example, in redox flow batteries, among other uses. Resulting electrodes, batteries, and other systems are also covered by the present disclosure.

### BACKGROUND

Electrochemical processes are poised to play a pivotal role in the evolving global power system as the efficient interconversion of electrical and chemical energy can enable the deployment of clean technologies that support the decarbonization of the electric grid, power the automotive fleet, and offer new opportunities for sustainable chemical manufacturing. Meeting these emerging needs requires transformational changes as the stringent performance, cost, and scale requirements cannot be met by many existing electrochemical technologies for energy storage and conversion.

Advancing the science and engineering of electrochemical stacks, which include flow-fields, electrodes, and membranes, can lead to dramatic cost reductions across a range of technologies. For example, porous electrodes are responsible for multiple, often critical, functions and/or roles in an electrochemical cell related to thermodynamics, kinetics, and transport. These functions and/or roles can dictate cell performance and durability, as well as feasible operating conditions. The electrodes can provide surfaces for electrochemical reactions (e.g., catalytic sites for redox reactions), enable uniform liquid electrolyte distribution with low hydraulic resistance, maintain good mechanical properties under compression (e.g., determine allowable pressure drop, cushion mechanical compression), and conduct electrons and heat, among other features. However, there is limited knowledge on how to systematically design and implement porous electrodes, and other materials of electrochemical stacks, in furtherance of emerging applications. This has resulted in the forced repurposing of available materials that are not tailored for these technologies and applications. Moreover, current generation materials, which are generally developed via empirical approaches, lack control of surface chemistry (e.g., compositional heterogeneity) and morphology (e.g., broad pore size distributions), which fundamentally limits the performance, durability, and consequently, the cost of resultant systems.

Essential to maximizing electrode performance is the ability to tailor microstructure and surface chemistry for application-specific targets. This is especially relevant for redox flow batteries (RFBs), in which solubilized redox active species are forced through porous electrodes in a reactor during charge and discharge. Because of its decoupled energy and power density, scalability, and potential to integrate renewables into the electric grid, the RFB is appealing for long duration energy storage. However, further cost reductions are necessary for widespread adoption. Reducing reactor, or electrochemical stack, cost by improving power output is an effective strategy towards bridging the economic gap. Unfortunately, while commercial porous carbon materials are functional, their property profiles are suboptimal for the redox couples (e.g., aqueous redox couples), which underpin many existing and developing RFB systems. The deterministic fabrication of advantageous microstructures with tunable surface chemistry would enable exploration of a larger design space and would further understanding of electrode-level performance descriptors.

Most porous electrodes used in present-day electrochemical technologies are based on micrometric carbon fibers assembled into coherent structures via a range of different methods that impart distinct properties (e.g., porosity, volume-specific surface area, flexibility) of relevance to device assembly and operation. As illustrated in FIG. 1, conventional manufacturing methods are energy-, materials-, and time-intensive and offer limited control over the resultant electrode microstructure and surface chemistry. For example, in some cases, gradients in porosity within diffusion media may be desired as a means of passively-controlling flow distribution (e.g., gas diffusion layer in fuel cells). Utilizing current approaches, multiple electrode layers of varying porosity would be stacked into the electrochemical cell, as opposed to a single material, thus increasing complexity and cost.

Accordingly, there is a need for improved porous electrodes, particularly those used in conjunction with systems that rely on convection of redox-active fluids like RFBs, to allow performance in the form of energy storage, conversion, and durability that is as good as or even better than existing technologies while reducing the costs and other complications associated with manufacturing and utilizing such porous electrodes on a large scale.

### SUMMARY

The present disclosure pertains to the development of new methods for fabricating porous carbon electrodes for use in electrochemical systems that rely on convection (e.g., forced convection) of gaseous or liquid reactants including, but not limited to, redox flow batteries (RFBs), low-temperature fuel cells, and electrolyzers. More particularly, the present disclosure provides for tandem approaches to advance porous electrodes with property sets suitable for RFBs, among other uses. In at least one instance, a bottom-up method of producing high surface-area carbon electrodes with interconnected porous microstructures with pore size, gradient, and structure adjustable via synthesis design parameters is provided. Combining spectroscopy, microscopy, and physicochemical characterization to cell performance, the viability of this material platform for elucidating structure-function relations in porous materials for RFBs is demonstrated.

In some embodiments, non-solvent induced phase separation (NIPS) can be implemented to synthesize tunable porous structures suitable for use as RFB electrodes that enable electrochemical flow technologies. In such embodiments, variation of the relative concentration of scaffold-forming polyacrylonitrile (PAN) to pore-forming polyvinylpyrrolidone (PVP) results in electrodes with distinct microstructure and porosity. Flow cell studies with two common redox species (e.g., all-vanadium and Fe²⁺/³⁺) can reveal that these electrodes can outperform traditional carbon fiber electrodes.

While the results of these approaches target RFBs, a person skilled in the art will recognize that the methods, implications, and techniques provided herein may be extended more broadly to electrochemical devices in which highly engineering porous electrodes would be beneficial and/or in electrochemical systems that rely on convection, for example, fuel cells because they can have one side that is more porous and another that is more dense, thus providing a gradient as desired by the present techniques. Still other examples in which the present techniques can be incorporated include but are not limited to electrolyte formulation, electrochemical cell chemical reactors for liquid phase and/or organic phase synthesis, porous transport layers in water electrolyzers, gas diffusion electrodes in CO₂-electrolyzers, liquid diffusion electrodes for liquid-phase electrochemical conversion reactors, electrochemically-assisted separations (e.g., capacitive deionization, ion-selective electrodes), and/or molecule sensor/detection applications that involve flow through electrolyte, particularly if coupled with coatings.

An exemplary method of fabricating a porous electrode includes exposing a polymer solution to a first solvent and subsequently exposing the polymer solution to a second solvent. The polymer solution includes a first polymer and a second polymer. The second solvent is effective to induce phase inversion such that the first polymer of the polymer solution is separated from each of the second polymer of the polymer solution, the first solvent, and the second solvent. The first polymer is porous and forms a porous membrane. As provided for herein, in the alternative, separation of the two polymers can occur without the use of a solvent.

The method can also include performing one or more post-treatment actions to the porous membrane. By way of non-limiting example, this can include crosslinking the porous membrane and/or one of carbonization of the porous membrane or graphitization of the porous membrane. In some embodiments, the method can include removing the porous membrane from the second solvent, drying the porous membrane, thermally stabilizing the porous membrane, and carbonizing or graphitizing the porous membrane. The post-treatment action can also include configuring the porous first polymer into an electrode having a desired electrode configuration. The electrode can be associated with a redox flow battery.

The method can also include adjusting a temperature at which the action of subsequently exposing the polymer solution to a second solvent occurs. In some embodiments, exposing a polymer solution to a first solvent occurs in a first bath that includes the first solvent, and subsequently exposing the polymer solution to a second solvent occurs in a second bath that includes the second solvent. In some such embodiments, the method can also include operating a roll-to-roll processing system to move the polymer solution from the first bath to the second bath, as well as to move the first polymer from the second bath to another location. In instances in which the method also includes performing one or more post-treatment actions to the porous first polymer when it is separated from each of the second polymer, the first solvent, and the second solvent, the another location can be a location at which at least one post-treatment action of the one or more post-treatment actions is performed.

Exposing a polymer solution to a first solvent can include casting the combination of the polymer solution and the first solvent onto a glass mold. In some embodiments, the first polymer can be hydrophobic and the second polymer can be hydrophilic, and the second solvent can include water. Exposing a polymer solution to a first solvent can result in a skin layer of at least one of the first polymer and the second polymer to be removed. After the phase inversion, the first polymer can be substantially devoid of macrovoids. A pore size of the first polymer after the phase inversion can be approximately in the range of about 0.5 nanometers to about 300 micrometers.

The method can include controlling a pore size of the first polymer that results from the phase inversion. For example, control can be such that a first section of the first polymer has pore sizes in one range and a second section of the first polymer has pore sizes in a second range, the first and second ranges of pores sizes including different ranges. The first and second sections can be differentiated from each other along a thickness of the first polymer, along a length of the first polymer, or along a width of the first polymer.

One exemplary embodiment of a polymer solution includes a first polymer having hydrophobic properties and a second polymer having hydrophilic properties. The first and second polymers are configured to form a polymer solution by mixing with a first solvent. The resulting polymer solution is configured to be separated into the first polymer and the second polymer by a second solvent via phase inversion. The second solvent includes water such that the phase inversion results in the first polymer being separated from each of the second polymer, the first solvent, and the second solvent, the second polymer remaining with each of the first solvent and the second solvent.

While many different recipes are provided for herein or are otherwise derivable in view of the present disclosures, in some embodiments the first polymer can include polyacrylonitrile. In some embodiments, the second polymer can include polyvinylpyrrolidone. By way of non-limiting example, a ratio of the first polymer to the second polymer can be approximately 1:1. In some such embodiments, the first polymer can include one gram of polyacrylonitrile and the second polymer can include one gram of polyvinylpyrrolidone. By way of further non-limiting example, a ratio of the first polymer to the second polymer can be approximately 3:4. In some such embodiments, the first polymer can include 0.857 grams of polyacrylonitrile and the second polymer can include 1.143 grams of polyvinylpyrrolidone. By way of still further non-limiting example, a ratio of the first polymer to the second polymer can be approximately 2:3. In some such embodiments, the first polymer can include 0.8 grams of polyacrylonitrile and the second polymer can include 1.2 grams of polyvinylpyrrolidone. Other polymers can be used in lieu of, or in addition to, polyacrylonitrile and polyvinylpyrrolidone, as can other ratios and amounts. In some embodiments, a pore size distribution can be tuned by changing a total solid content of the initial polymer solution in a range from about 16% to about 19% wt of the first and second polymers relative to the first solvent.

A porous membrane formation kit can include a polymer solution, such as those provided for above or elsewhere herein, a first solvent, and a second solvent. The first solvent can be configured to mix with the first polymer and the second polymer to form the polymer solution, and the second solvent can be configured to separate the first polymer from the second polymer via phase inversion. The second solvent can include water. The first solvent can include dimethylformamide. For example, the first solvent can include 10 mL of dimethylformamide.

An exemplary embodiment of fabricating a redox flow battery can include exposing a polymer solution to a first solvent, the polymer solution comprising a first polymer and a second polymer; and exposing the polymer solution to a second solvent to separate the first polymer from each of the second polymer of the polymer solution, the first solvent, and the second solvent. The first polymer is formed into a porous electrode.

### BRIEF DESCRIPTION OF DRAWINGS

This disclosure will be more fully understood from the following detailed description, taken in conjunction with the accompanying drawings, in which:

FIG. 1 is a schematic illustration of one example of a gas diffusion layer fabrication process reproduced from a paper entitled “Powering up fuel cells from SGL Carbon GmbH of Meitingen, Germany,” and available at https://www.sglcarbon.com/pdf/SIGRACET-Whitepaper.pdf;

FIG. 2 is a schematic illustration of one exemplary embodiment of a porous electrode fabrication methodology;

FIG. 3A are magnified illustrations of various microstructures of porous electrodes with (I) macrovoids, (II) voids of substantially equal size, e.g., isoporous, and (III) a porous gradient;

FIG. 3B is a schematic illustration of one exemplary embodiment of a process for production of flat sheet carbonized materials using phase separation;

FIG. 4A is a reconstructed 3D rendering from X-ray computed tomography of a porous electrode derived from phase separated materials in a 1:1 ratio and representative cross sections of the materials in the various planes;

FIG. 4B is a reconstructed 3D rendering from X-ray computed tomography of a porous electrode derived from phase separated materials in a 3:4 ratio and representative cross sections of the materials in the various planes;

FIG. 4C is a reconstructed 3D rendering from X-ray computed tomography of a porous electrode derived from phase separated materials in a 2:3 ratio and representative cross sections of the materials in the various planes;

FIG. 5 is a graph showing polarization curves of the electrodes depicted in FIGS. 4A-4C compared to a commercial SGL 29AA electrode;

FIG. 6 is a schematic illustration of one exemplary embodiment of a roll-to-roll continuous manufacturing process that utilizes the fabrication methodology of FIG. 2;

FIG. 7A is a schematic side view of one exemplary embodiment of a low temperature acidic fuel cell having multilayered materials;

FIG. 7B is a schematic side view of a low temperature acidic fuel cell having phase separation;

FIG. 8A illustrates a scanning electron micrograph of a commercial woven electrode (AvCarb 1071);

FIG. 8B illustrates a scanning electron micrograph of a commercial carbon paper (SGL 29AA);

FIG. 8C illustrates a scanning electron micrograph of an electrode having a mass ratio of 2:3 for PAN:PVP;

FID. 8D illustrates discharge polarization curves from incorporating a material prepared in a manner as illustrated in FIG. 2 in a single electrolyte flow cell;

FIG. 8E illustrates from incorporating a material prepared in a manner as illustrated in FIG. 2 in a single electrolyte flow cell;

FIG. 9A illustrates electrochemical impedance spectroscopy curves from discharge polarization curves with power density curves from incorporating a material prepared in a manner as illustrated in FIG. 2 in an all-vanadium full cell; and

FIG. 9B illustrates electrochemical impedance spectroscopy curves from incorporating a material prepared in a manner as illustrated in FIG. 2 in an all-vanadium full cell.

### DETAILED DESCRIPTION

Certain exemplary embodiments will now be described to provide an overall understanding of the principles of the techniques, structure, function, manufacture, and use of the methods and resulting devices and systems disclosed herein. One or more examples of these embodiments are illustrated in the accompanying drawings. Those skilled in the art will understand that the methods, and resulting devices and systems, specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Further, to the extent features, sides, objects, steps, or the like are described as being “first,” “second,” “third,” etc., such numerical ordering is generally arbitrary, and thus such numbering can be interchangeable. Still further, to the extent the present disclosure describes applications of the described methods and systems to RFBs, such disclosures are commonly applied to aqueous flow batteries, but may also be applied to non-aqueous flow batteries.

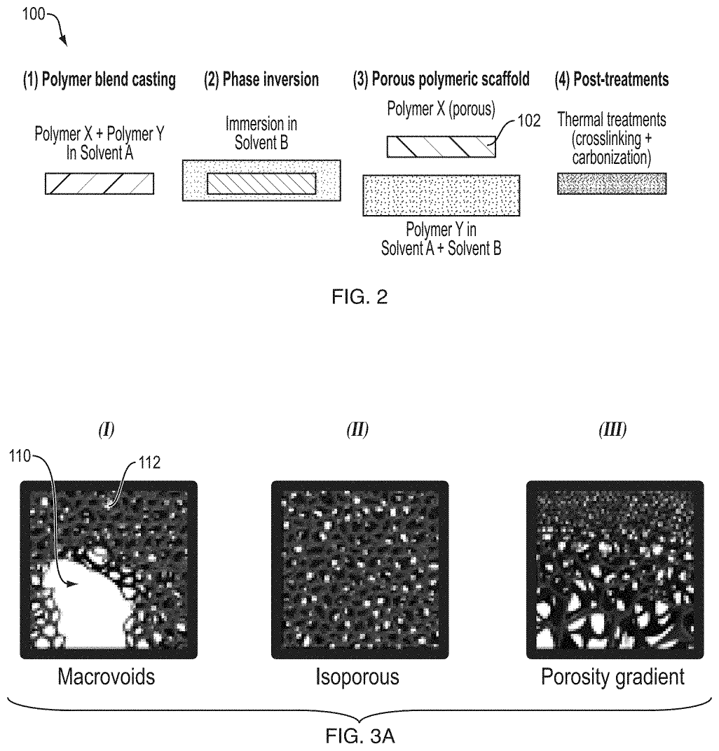

The present disclosure provides for the use of a process of polymer phase separation 100, also known as phase inversion, to synthesize porous electrodes for use in RFBs. One non-limiting example of this technique is illustrated in FIG. 2. As shown, a polymer or polymer solution that includes two polymers—polymer X and polymer Y—can be dissolved in a first solvent, as shown solvent A. This action is sometimes referred to as polymer blend casting because the polymers can be cast as a film. In some embodiments one of the two polymers can be hydrophobic (e.g., polyacrylonitrile) and the other hydrophilic (e.g., polyvinylpyrrolidone). One exemplary solvent A can be dimethylformamide. The result of soaking the polymer solution in solvent A is that a skin layer of the polymer solution is removed. It was discovered that removing the skin layer allows for improved permeability of the resulting membrane, improved mass transport when used in conjunction with RFB applications, and allows for more pores to be used in conjunction with the resulting membrane as compared to when the skin layer remains. At least some of these improvements, in turn, allow for better capital and operating costs in use. This was a surprising result because prior to the present disclosure the skin layer(s) of polymer(s) and polymer solutions were typically kept intact. In at least some embodiments, a semi-permeable membrane can be disposed over the casted polymer/polymer/solvent blend prior to submersion into the coagulation bath, i.e., solvent B. This can slow infiltration into the membrane, thus imparting an additional handle of control over the microstructure.

Still further, in some embodiments, the solvent bath involving solvent A helps remove macrovoids, which was also both a key finding for achieving microstructural control and a surprising result. This is at least because in a simple and short step a microstructure of an electrode can be tailored on several aspects, such as the solvent A in contact with the polymer solution (polymer+additives+solvent A) diffuses to the polymer solution thus decreasing the polymer concentration. This creates a systematic removal of the top layer and the pore size of the top side of the membrane can be tuned. Another aspect is that having a thin layer of solvent A adsorbed onto the polymer solution before immersion in solvent B creates a buffer layer which regulates the solvent A inflow towards the polymer solution and the solvent B outflow from the polymer solution. This again can create a systematic removal of the macrovoids in the membrane microstructure. As a consequence of at least these two aspects, treatment of the polymer solution with solvent A can impede both the formation of macrovoids and skin layer even in samples having low polymer concentration. Those samples having low polymer concentration can exhibit much bigger pore size/gradient than the same samples directly immersed in solvent B without treatment with solvent A.

The polymer-blend casting step also affords large flexibility during the process (i.e., greater than existing methods), and in the resulting material(s). For example, the polymer-blend casting of the present disclosure provides enhanced flexibility in forming a mixture composition. More specifically, the make-up of one or more of solvent(s), polymer(s), and/or other additives can be more easily adjusted in view of the polymer-blend casting step.

By way of non-limiting example, while the present disclosure utilizes solvent A in the polymer-blend casting step, a mix of solvents can be utilized instead. Alternatively, a polymer can be utilized in the polymer-blend casting step that is configured to undergo phase separation by a trigger, for instance in response to a temperature, in lieu of utilizing a solvent at all. Other ways of inducing phase separation without a solvent can also be used.

By way of further example, the polymer-blend casting of the present disclosure provides enhanced flexibility by way of casting technology. To the extent the present disclosure provides for knife casting, other technologies can be used to deposit the polymer blend. For example, if more complex shapes are desired, the uses of a mask(s) in conjunction with injection methods can be utilized. The ability to pattern, form, or otherwise shape the desired mold shape and depth is permitted by the present disclosures due to the enhanced geometric control it provides. The ability to control a thickness of the resulting material and/or electrode can be particularly beneficial to overall performance. Alternatively, or additionally, two or more polymer blends can be cast on top of each other to obtain a multilayered material. In such instances, a first polymer blend can be blended and/or treated in a manner that yields pores in a first size range and a second polymer blend can be blended and/or treated in a manner that yields pores in a second size range, the two size ranges being different (i.e., one having larger pore sizes than the other). As a result, the resulting material and/or electrode can have different pore sizes across different sections of the material and/or electrode, the different sections being differentiated along a thickness of the material and/or electrode (i.e., the first polymer as described elsewhere herein). In other embodiments, the different pore sizes can be created in sections differentiated along a length of the material and/or electrode (i.e., the first polymer as described elsewhere herein) or along a width of the material and/or electrode (i.e., the first polymer as described elsewhere herein). In embodiments that include a multilayered material with different layers, or sections as also provided for, being configured to have different porosities to create a gradient across the layers (or sections), multiple layers can be treated at the same time while allowing the different layers (or sections) to have different porosities. This can be more efficient than having to treat each layer (or section) separately to achieve the different porosities. For instance, in instances where knife casting is used to cast a blended material, the knife can be applied to the layers (or sections) simultaneously such that the layers (or sections) are cast at approximately the same time while still having different porosities. This can be advantageous in many contexts, including but not limited to the formation of fuel cells.

By way of still further example, the polymer-blend casting of the present disclosure provides enhanced flexibility by way of allowing for the easy use of one or more additives. A non-limiting example of a potential additive includes adding electrocatalytic materials (e.g., inorganic materials) to a polymer blend that would be capable of surviving carbonization. Additives can also be added any of solvent A, solvent B, and/or any of the materials used to form the polymer blend. For example, additives can be added to the coagulation bath, i.e., solvent B, to directly target surface functionalization.

Additionally, in view of the present disclosures, a variety of pore sizes can be achieved, including on the same membrane and/or same electrode. The ability to vary pore sizes across a surface area provides benefits not previously easily achievable because different portions of the membrane/electrode/etc. can be formulated to serve particular benefits and/or functions. For example, big pores, e.g., pores that are larger than 50 μm, with a controlled architecture can be achieved. Prior to the present disclosures, most of the applications of phase-inversion membranes (e.g., water filtration) require small pores (e.g., sub-micron) to be able to retain solutes of interest (e.g., bacteria, solids in suspension, etc.). The use of big, or large, pores is beneficial in the context of the present disclosure at least because they increase permeability, and thus reduce pressure drop and pumping costs, while enhancing convective mass transport. However, small pores can also provide benefits, as understood by a person skilled in the art, including but not limited to improving local mass transfer due to reduced diffusion distances and high surface area leading to faster reaction kinetics.

In some instances, reducing or eliminating macrovoids is desired, for example to allow for a gradient structure, while in some other instances, having macrovoids can be helpful, for example to provide lower pressure drop. The preference of including, reducing, or eliminating macrovoids can depend on a variety of factors, including but not limited to the chemistry and materials involved.

The resulting material from the casting step can subsequently be immersed in a second solvent, as shown solvent B. This action is sometimes referred to as phase inversion. Solvent B is selected in a manner such that it selectively dissolves one of the two polymers, i.e., either polymer X or polymer Y, leaving behind a porous scaffold composed of the other polymer. Due to this phase inversion action, another level of tenability of the final structure is provided. It allows for the nature of solvent B to be adjusted to change the thermodynamics and/or kinetics of the phase inversion. For example, the temperature of the coagulation can play a significant role, with higher temperatures typically generating bigger pores, with an increased likelihood of more macrovoids. Further, as provided for above, additives can be included to influence the phase inversion and also to functionalize the porous scaffold of the polymer.

The resulting scaffold 102 is illustrated in the third image of FIG. 2, with polymer X being porous and polymer Y having been in solvent A and solvent B, i.e., polymer Y being the polymer that is selectively dissolved in solvent B. As a result of the processes provided for herein, the pores in polymer X can be more controlled than in previous formation techniques, thereby allowing for different sized pores to be strategically formed across a surface area of the membrane and/or electrode. The difference in size can be large and planned, thus providing for the ability to control particular results and features to exist on the resulting membrane and/or electrode. In the present instance, by moving from traditional carbon fiber substrates to the new architectures afforded by the present disclosures, better electrode performance was achieved. In view of the present disclosures, scaffolds with highly controllable pore sizes is possible.

For example, in some embodiments, a pore size of the porous polymer can be approximately in the range of about 0.5 nanometers to about 100 micrometers, with macrovoids being even larger, e.g., approximately 200 micrometers or greater, though in some embodiments, macrovoids can include finger-like structures approximately in the range of about 50 micrometers to about 300 micrometers, about 50 micrometers to about 400 micrometers, about 50 micrometers to about 700 micrometers, and/or about 50 micrometers to about 1 millimeter. Moreover, in some embodiments, the pore size can include smaller pores, sometimes referred to as microvoids or micropores, which can help provide high surface area zones within an electrode(s), which may be desirable for RFB applications, among other uses. Again, it is the ability to control these sizes that is a particular benefit of the present disclosures, as pore sizes across a range of sizes, even beyond what is stated above, can be achieved. Presently existing materials commercial materials cannot generally control pore size distribution across a thickness direction (i.e., a “through-plane” as understood by a person skilled in the art), while the present disclosure affords this capability. Further, the present disclosure has shown the ability to prepare materials that feature near-unimodal pore size distribution, all the way to electrodes that feature a gradient factor of around 40, where the gradient factor is a ratio between a largest pore and a smallest pore (bottom and top layers, respectively). Moreover, in some embodiments, bimodal and trimodal pore size distributions can be prepared with the present disclosure. It will be appreciated that a “micropore” includes pores approximately in the range of about 0.1 micrometers to about 10 micrometers. The term “micropore” as used herein is different than the formal definition by the International Union of Pure and Applied Chemistry (IUPAC), which typically qualifies a micropore as a pore with equivalent diameters less than 0.2 nanometers.

Pore size can be controlled in a variety of manners. For example, it can be controlled by replacing the solvent on the polymer blend. By way of further example, it can be controlled by modifying the molecular weight of the polymer (e.g., polymer X and/or PVP as provided for herein). Alternatively, or additionally, pore size can be tuned by regulating temperature. Each of replacing solvent, modifying molecular weight of the polymer, and regulating temperature are discussed in greater detail below. It will be appreciated that varying one or more of these parameters while maintaining the remaining parameters unchanged can afford control of one or more of the pore size distribution (PSD), porosity, or an electrochemically accessible surface area (ECSA) of the prepared electrodes.

In some embodiments, the gradient can also be tuned, for example with temperature and/or various pre-wetting steps. Still further, the removal, presence, or morphology of the skin layer can be controlled by adjusting the pre-solvent bath, i.e., solvent A, and/or the vapor atmosphere in contact with the casted polymer (i.e., relative humidity). The resulting scaffold 102 can subsequently be exposed to one or more post-treatments. These treatments can include, by way of example, thermal treatments. Non-limiting exemplary thermal treatments can include crosslinking the polymer and/or carbonizing/pyrolyzing the polymer to form a carbonaceous porous electrode. Other treatments can include the use of nitrogen, oxygen, ozone, argon, helium, carbon, etc. as part of the surrounding atmosphere. The synthesis methodologies that can be utilized in conjunction with the present disclosures can be flexible, as described further below.

At least some of the key advantages of the presented methodology include: (1) multiple synthetic handles to tune final electrode microstructure; (2) a broad palette of polymeric precursors with distinct properties; (3) compatibility of existing at-scale manufacturing infrastructure; and/or (4) opportunity to introduce additives (e.g., electrocatalysts, reactants) into the polymer blends to impart favorable properties on the final product. The processes provided for herein can have multiple degrees-of-freedom that can be harnessed to achieve desired property sets, including but not limited to the choice of polymers and solvents, the phase-separation temperature, the precipitation bath, use of additives, and/or the final thermal treatment, among others provided for herein or otherwise derivable from the present disclosures.

A person skilled in the art will recognize that additional ways to initiate a phase separation process exist. Some non-limiting examples of such a phase separation process includes polymerization-induced, temperature-induced, non-solvent induced, or vapor-induced phase separation. It will be appreciated that one or more of the above-mentioned phase separation processes can be performed alone or in combination to form a viable electrode. A person skilled in the art, in view of the present disclosures, would be able to initiate a phase separation process tying the described methods and systems and one or more of these non-limiting examples (e.g., polymerization-induced, temperature-induced, non-solvent induced, vapor-induced phase separation). An example of phase separation using a non-solvent provided by the present disclosure includes non-solvent induced phase separation (NIPS), which includes immersing a material into a non-solvent to initiate the precipitation, as discussed further below. To the extent immersion, drying of the phase separated material, and/or thermal stabilization and carbonization steps are used in NIPS, a detailed discussion of the common elements with the porous electrode fabrication method is omitted for the sake of brevity in view of the discussion above with respect to FIG. 2.

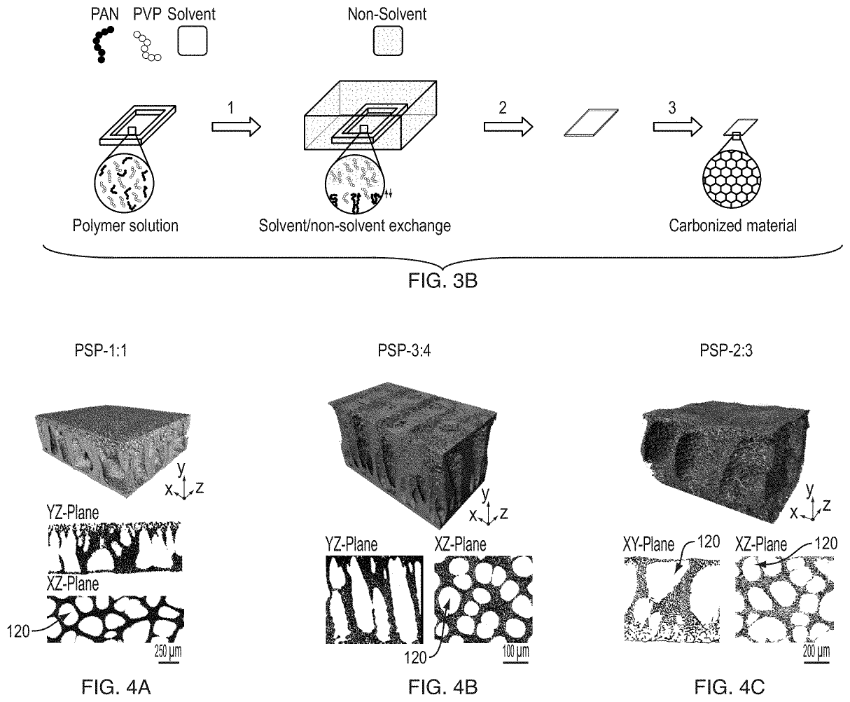

FIGS. 3A-3B illustrate an exemplary embodiment of fabricating RFB electrodes using NIPS, which enables the generation of non-fibrous porous materials, e.g., porous electrodes, with long-range interconnected microstructures with unique property profiles that are unattainable in current fibrous materials and achievable through systematic variation of easily adjustable parameters. The interconnected porous networks offer the opportunity for gradient porosity electrodes, which can be connected to electric grid and intermittent renewable energy sources, as well as used as electrodes in supercapacitor and electro-sensing applications. Comparison of such NIPS electrodes can outperform a standard SGL 29AA electrode due to reduced kinetic and mass transport overpotentials, which suggests considerable promise for high power operation using the NIPS electrodes.

Some exemplary embodiments of the microstructures included in the NIPS electrode are shown in FIG. 3A. As shown in (I), the microstructure of the porous electrodes can include one or more macrovoids 110 interspersed through the electrode. The macrovoids 110 can include regions of non-spherical approximately greater than 100 μm gaps that are interconnected to, and outlined from, porous networks having smaller voids. The remaining pores 112 having smaller pore sizes can include micropores, or be substantially isoporous throughout the remainder of the electrode. As discussed above, while having macrovoids in the microstructure of the porous electrode can be helpful in some instances to lower pressure drop, in some embodiments, elimination of macrovoids is desired in lieu of a more homogeneous porosity, e.g., isoporous, or having a porosity gradient throughout. These microstructures are shown in (II) and (III). In some embodiments, variations of the pore size can occur across a thickness of the electrode thickness, with smaller pores (i.e., higher surface area) closer to the membrane, in a fashion that can be beneficial for transport phenomena within the electrode.

It will be appreciated that electrodes with complex pore profiles may be achieved in a single manufacturing NIPS process instead of several distinct fiber-production processes. For example, NIPS can be used to synthesize porous electrodes suitable for electrochemical systems with forced convection.

FIG. 3B illustrates the phase separation process used to yield flat sheet carbonized materials such as geometrically uniform electrodes using NIPS. As shown, a viscous mixture of polyacrylonitrile (PAN) and pore forming polyvinylpyrrolidone (PVP) can be dissolved in a solvent. Some non-limiting examples of solvent can include N,N-dimethylformamide (DMF), dimethylformamide (DMF), N-Methyl-2-pyrrolidone (NMP), Dimethyl Sulfoxide (DMSO), PolarClean(R) (methyl-5-(dimethyla-mino)-2-methyl-5-oxopentanoate, N,N-dimethylacetamide, TEP (triethylphosphate), and Tetrahydrofuran (THF), among others. The mixture can be fully mixed after heating and casted in a glass mold. The casted mixture can subsequently be immersed in a non-solvent, e.g., a water bath (1), to initiate phase separation into polymer-rich and polymer-lean regions through solvent/non-solvent exchange. During immersion and the solvent/non-solvent exchange, the water-soluble PVP can leach into solution, leaving behind an insoluble porous PAN scaffold. The phase separated material can then be dried (2) and exposed to thermal stabilization and carbonization (as discussed, for example, in the Experimental section below) to form the porous electrode.

It will be appreciated that varying one or more parameters of the process can impact the porosity of the resulting porous electrode. For example, using the NIPS process discussed above can produce porous electrodes with a variety of microstructures. The macrovoid-containing, isoporous, and/or gradient porosity electrodes, as shown in FIG. 3A, can be fabricated through variation of a range of easily-accessible parameters including polymer concentration, bath temperature, and solution viscosity.

While the present disclosure contemplates a variety of recipes that can be used to formulate porous electrodes (e.g., RFB electrodes), one non-limiting recipe that has been effective is as follows:
To make the polymer melt, a total of about 2 grams of polymer was mixed in about 10 mL of dimethylformamide (DMF), with varying ratio of polyacrylonitrile (PAN) and polyvinylpyrrolidone (PVP). The following three ratios were used as a recipe for the polymer melts:
˜1:1-˜1 gram PAN, ˜1 gram PVP, ˜10 mL DMF;
˜3:4-˜0.857 gram PAN, ˜1.143 gram PVP, ˜10 mL DMF; and
˜2:3-˜0.8 grams PAN, ˜1.2 grams PVP, ˜10 mL DMF.
Following polymer mixing via stirring, the blend can be casted onto a glass mold in the shape of a rectangle or square with controllable length, width, and thickness to tune resulting membrane dimensions. After casting, the glass mold and membrane can be lowered into a water-rich bath, driving phase separation of the hydrophobic (PAN) and hydrophilic (PVP), and leading to the formation a freestanding membrane structure. The membrane can be allowed to soak for approximately 10 hours (a person skilled in the art will recognize this time can be less or more, for example at least about 1 hour or at least about 15 hours), then removed, dried under vacuum at about 80° C., thermally stabilized in air at about 270° C. for about 1 hour with ramp rate about 2° C./min with an approximately 90 gram weight (as compression to prevent warping), and then carbonized in nitrogen atmosphere with an approximately 90 gram weight at (1) about 850° C. for about 40 minutes with ramp rate of about 5° C./min and (2) about 1050° C. for about 40 minutes with ramp rate of about 5° C./min.

Around the above recipe, additional derivative recipes that result in materials with distinct three-dimensional morphology have been created, and can be created, in view of the present disclosures. For example, the presence of macrovoids in the porous structure can be reduced or even eliminated, also referred to herein as being substantially devoid of macrovoids, the presence and thickness of dense “skin” layers that form on the water-polymer film interface can be controlled, pore size across a broad range (e.g., ˜0.5 nanometers to ˜100 micrometers, though, in some embodiments, the pore size can range to about 400 micrometers, about 700 micrometers, and/or about 1 millimeter) can be tuned, and porosity gradients across the electrode thickness can be imparted. In some embodiments, a porous structure that is substantially devoid of macrovoids means that there is no more than one percent of a surface area of the porous structure covered by macrovoids. With respect to at least the present disclosure, a macrovoid is considered to be a distinct, discontinuous space that is visually obvious, and more particularly is relatively larger (e.g., by a factor of five or greater), by cross-sectional length as compared to an average pore size across the same surface area in the structure. As described herein, adjusting a ratio of polymer X to polymer Y, pre-dipping the material in solvent A, and/or the mixed coagulation bath associated with the bath associated with solvent B are all ways by which macrovoids can be reduced, minimized, or all together eliminated.

Further, the above-recipe is by no means limiting. The values and materials provided are merely some representative examples of values and materials that can be used to achieve the benefits of the present disclosure. Varying the ratio of scaffold forming PAN to PVP in the NIPS casting solution can create a class of materials with related but differing property sets and, consequently, electrochemical performance. Other ratios, amounts, and materials can be used to form the polymer blend and solvents. By way of non-limiting example, the second solvent is described above as a water-rich bath. In some instances, it can be 100% water, but in other instances it can be less than 100% (e.g., 70% or greater) and still be water-rich. Still further, other non-solvents can be used in lieu of water, including in conjunction with additives, as described above. By way of further non-limiting example, the recipe above provides for soaking the membrane in the second solvent for 10 hours, and provides alternatives of at least about 1 hour and at least about 15 hours, but often these times can be even shorter, such as a manner of seconds or minutes. The amount of time needed to soak in the in the second solvent can be impacted, at least in part, by a thickness, viscosity, and/or chemical make-up of the solvent, and/or a thickness and/or chemical make-up of the membrane. One such instance can be the roll-to-roll process technology described below, in which exposure of the blend to the second solvent can occur in seconds during the manufacture process. Keeping the roll-to-roll process moving can be important to achieve a viable scaled up processing method, and thus phase inversion can happen quickly to prevent a back-up in the processing. By way of still a further non-limiting example, while the recipe above provides for drying to occur under vacuum at about 80° C., other drying techniques that do not involved vacuums and/or at other temperature values higher and lower than 80° C. can also be utilized without departing from the spirit of the present disclosure. For instance, any form of applied pressure to the membrane can be sufficient to achieve the same end result.

FIGS. 4A-4C illustrate exemplary embodiments of the recipe discussed above for formulating porous electrodes derived from samples having varying ratios of PAN to PVP, which are referred to as PSP-1:1, PSP-3:4, and PSP-2:3 for brevity, where PSP indicates phase separated materials, and the ratio is the relative PAN:PVP amount by mass. A comparison of the cross-sections of each of the PSP electrodes shows that the PSP-3:4 embodiment includes more aligned macrovoids as compared to the PSP-1:1 and PSP-2:3 embodiments, both of which have substantially similar structures. Moreover, increasing the content of the PVP as compared to the PAN increases an overall porosity. In fact, the physical properties that can be quantified, e.g., porosity, PSD, can be refined depending on the ratio of PAN to PVP that is used.

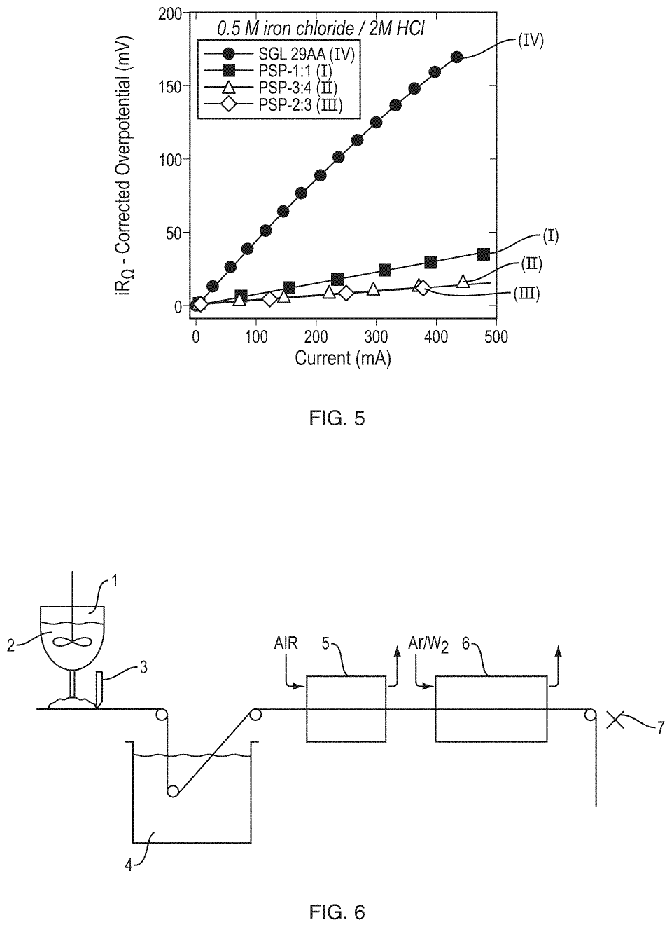

FIG. 5 shows the current output at a given applied overpotential for the phase separated electrode samples in FIGS. 4A-4C compared to a commercial SGL 29AA pristine electrode at an estimated linear velocity of 5 cm s⁻¹. The average thicknesses of the synthesized electrodes were ca. 670±56 though the thickness of the electrodes can be varied. As shown, the 1:1 PSP electrode (I) exhibited lower polarization losses as compared to the 3:4 (II) and 2:3 (II) PSP electrodes, Moreover, all of the PSP electrodes, regardless of the PAN:PVP ratio, exhibited significantly lower polarization losses as compared to the SGL 29AA electrode (IV) in a single-electrolyte iron chloride flow cell (Fe²⁺/Fe³⁺ 50% state of charge in aqueous 2M HCl supporting electrolyte).

The versatility of the phase separation process for making porous electrodes can be evaluated by characterization of the microstructural/in situ performance of the prepared electrodes in RFBs. For example, replacing the casting solvent can finely tune a pore size distribution (PSD) and/or an electrochemically accessible surface area (ECSA) of the synthesized porous electrode. Some non-limiting examples of casting solvents showing improved performance can include dimethylformamide (DMF), N-Methyl-2-pyrrolidone (NMP) and Dimethyl Sulfoxide (DMSO), among others. In the case of DMSO, for example, this top layer formation can be systematic and could not be suppressed by longer resting time before immersing the cast polymer in the coagulation bath. For NMP, it was found that increasing the resting time from about 10 minutes to about 20 minutes helped suppress the top layer formation and obtain similar performance compared to electrodes cast with DMF. A person skilled in the art will recognize that using a mixture of different solvents, even though complexifying the phase separation process, may lead to a higher control of the electrode microstructures.

In some embodiments, the solvent can negatively impact final performance of the porous electrode due to the formation of a dense top layer. For example, formation of the dense top layer can be detrimental to the electrode performance as the top layer can decrease the ionic movement across the electrode, thereby impacting power density.

Alternatively, PSD can also be finely tuned by changing the total solid content of the initial polymer solution. While tuning PSD for solid contents were observed for contents that range from about 16% to about 19% (wt of PAN+PVP/wt of solvent), it will be appreciated that the relative solid content of PAN and PVP can be changed in broader ranges to further alter the pore size distribution. Each of porosity and PSD is sensitive to changes in relative solid content and can therefore be adjusted by altering the solid content.

Moreover, in some embodiments, changes in coagulation bath temperature tend to have minimal impact on the PSD while ECSA of the resulting porous electrode observe greater impacts. For example, for coagulation bath temperatures approximately ranging from about 5° C. to about 40° C., the PSD was found to remain relatively stable while the ECSA of the about 40° C. sample was found to be higher than that of the about 5° C. and the about 21° C. baths. For example, about 40° C. baths had a 5-fold increase in ECSA compared to all the other electrodes cast from DMF, which were all around 0.6-0.8 m² g⁻¹.

Scaling-Up for Large-Volume Manufacturing

The synthesis methodologies provided above are also compatible with large-volume manufacturing, such as via roll-to-roll process technology. FIG. 6 provides one non-limiting example of the application of the present methodologies in accordance with a roll-to-roll process technology.

As shown in FIG. 6, a polymer blend casting equivalent to that of FIG. 2 is provided by mixing (1) a polymer solution (2), and then casting the mixed solution, for example using a doctor blade or knife (3), to make the resulting casting substantially flat. A number of different polymers can be used to make the polymer solution (2), including but not limited to the solution provided above, and other derivatives disclosed herein or made possible by the present disclosures. Likewise, many different techniques can be used to mix or blend the polymer(s) or polymer solution, and thus reference to a mixer, or the action of mixing, is by no means limiting. Other techniques known for causing two polymers to associate, mix, etc. with each other can be utilized. Similarly, many different techniques can be used to cast the mixed polymer solution, and thus reference to using a knife or blade to cast is by no means limiting. By way of non-limiting example, in lieu of, or in addition to, using a knife or blade to cast the mixed polymer solution, spraying can used to cast the mixed polymer solution.

The liquid bath (4) illustrated in FIG. 6 is the equivalent of the phase inversion portion of FIG. 2. As shown, the casted mixed solution is delivered to the bath using rolls. A person skilled in the art, in view of the present disclosures, will understand how a roll-to-roll processing technology, like the one illustrated in FIG. 6, operates, and thus a detailed explanation of the same is unnecessary. As shown, there are at least four rolls or pulleys used to move the cast material from being cast, to the phase inversion bath, and then to various post-treatment stations. Fewer or more rolls can be used, and many different configurations of rolls can be possible. A person skilled in the art, in view of the present disclosures, will understand various factors that can be adjusted to impact the overall membrane and/or electrode that is produced. A number of these factors are described above, and by way of further non-limiting example, a liquid bath height under which the electrode is phase separating can be controlled to impact, for instance, the resulting thickness of the membrane and/or electrode. By way of still another non-limiting example, hydrostatic pressure associated with the process can also impact the results. The phase inversion processing provided for in FIGS. 2 and 6 can be combined with other additional post-processing or coating steps known to those skilled in the art and/or provided for herein, including but not limited to applying polymer coating and spraying electrocatalysts, among others.

From the liquid bath (4) emerges a porous polymer, such as polymer X from FIG. 2, as shown in the third image from FIG. 2. Just as in FIG. 2, one or more post-treatment actions can be performed on the porous polymer. In the embodiment illustrated in FIG. 6, there are three post-treatment actions: crosslinking (5), carbonization (6), and cutting (7), although fewer or more post-treatment actions can be performed, including actions beyond crosslinking, carbonization, and cutting. As shown, the crosslinking can occur in air, the air being disposed in a chamber, bath, or other area through which the porous polymer is moved. In some embodiments, air can be approximately in the range of about 230° C. to about 330° C., for example at about 270° C., although other temperatures are possible. As temperature changes, it can influence mechanical properties of the resulting membrane and/or electrode. Typically this temperature is lower than the temperature at which some other post-treatment steps that can be performed are done, such as carbonization, which is described further below. An approximate range of possible temperatures for such a post-treatment cross-linking process can be about 650° C. to about 3000° C. As a result of the cross-linking, mechanical properties of the polymer scaffold can be improved. Notably, references to the polymer scaffold as opposed to “the resulting membrane and/or electrode” are used interchangeably herein.

A second illustrated post-treatment action includes carbonization. Alternatively, a post-treatment action can include graphitization, which typically occurs at temperatures even greater than carbonization, such as greater than about 2000° C., causing the carbon content to exceed a threshold (e.g., over about 95%, over about 97.5%, or over about 99.5%, among others) and the structure graphitizes. As shown, the carbonization or graphitization can occur in an inert atmosphere, such as N₂ or Ar, the atmosphere as show being within a chamber, bath, or other area through which the porous polymer is moved. Thermal stabilization and/or cross-linking, on the other hand, typically occurs in air. In some embodiments, a temperature at which carbonization can occur can be approximately in the range of about 650° C. to about 2000° C., and a temperature at which graphitization occurs is greater than about 2000° C. As a result of the carbonization or graphitization, the porous material can conduct electrons and heat.

A third illustrated post-treatment action includes cutting. Cutting can occur before or after other post-treatments, but in the illustrated embodiment cutting is the final post-treatment action. The cutting can be performed to configure the porous polymer to the desired shape and/or size, such shape and size depending, at least in part, on the configuration of the other components with which the resulting porous polymer will be used. A person skilled in the art will recognize many different techniques for cutting a desired amount and shape of porous polymer from a polymer roll. The present disclosures allow for a user to selectively design a size, shape, and materials for use in an electrode, thus allowing the user to selectively design an ideal electrode for a desired use. This is particularly the case because of the ability to tune a thickness of the resulting membrane and/or electrode, for instance by a casting mold size and/or compression during carbonization/graphitization, among other tunable features provided for herein.

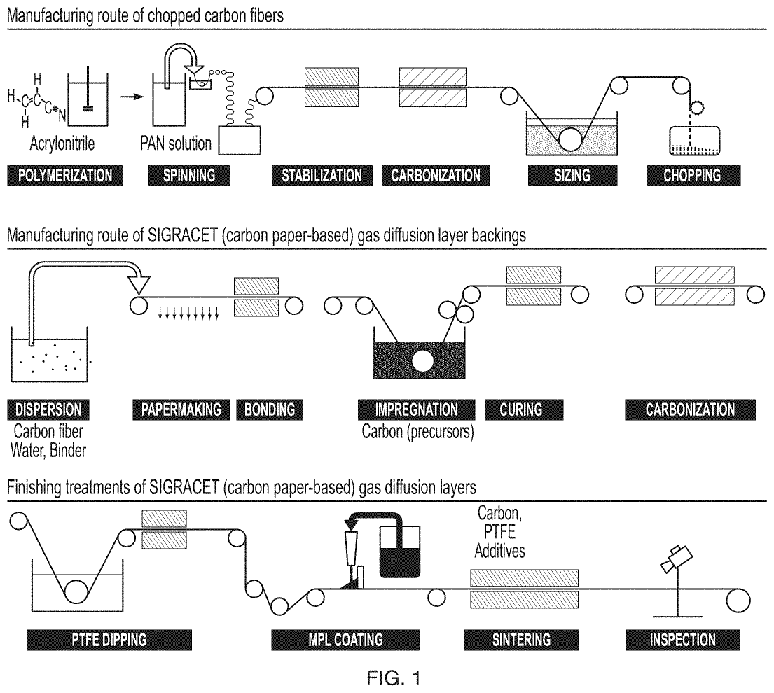

The large-volume manufacturing afforded by the present disclosures provides key manufacturing and potential cost advantages over previously existing fabrication methods, like the methods shown in FIG. 1. For example, the present disclosure provides for a reduction of process steps due to the removal of carbon fiber making steps (e.g., five steps: spinning, sizing, chopping, dispersing, papermaking). These steps are replaced by casting (e.g., a doctor blade deposition of the polymer solution onto a substrate) and immersing a polymer solution into a precipitation solution for phase separation. The thermal steps illustrated can be traditional carbonization steps also common to the process described in FIG. 1, although lower temperatures may be able to be used to prepare the electrodes due to the exemplary performance results from the present fabrication methods. These performance results are explored in greater detail below.

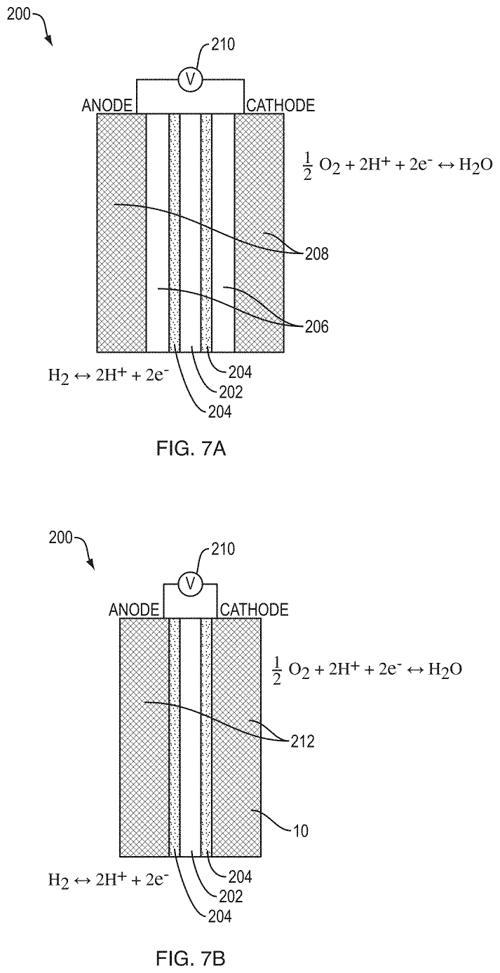

FIGS. 7A-7B illustrate an exemplary embodiment of a fuel cell 200 utilizing the methodologies discussed above. For example, FIG. 7A illustrates reactor components of a low temperature acidic fuel cell 200 that includes a proton exchange membrane 202, catalytic layers 204, microporous layers (MPL) 206, and gas diffusion layers (GDLs) 208. GDLs 208 are typically composed of carbon fiber substrates that are coated with fluorinated polymer, e.g., polytetrafluoroethylene, to increase hydrophobicity. Altogether, the catalytic 204, microporous 206, and gas diffusion layers 208 comprise the electrodes for the fuel cell 200 to enable the interconversion of gaseous reactants to products that are mixed-phase (gaseous and gaseous and liquid). As shown, an electric potential 210 can be applied across the GDLs, which can cause oxidation in an anode and reduction in a cathode of the fuel cell 200. For example, upon discharge, hydrogen can be oxidized at the anode, liberating protons and electrons, which at the cathode, react with oxygen to form water.

FIG. 7B illustrates the fuel cell 200 with phase-separated electrode material 212 formed on opposite sides of the proton exchange membrane 202 and the catalytic layers 204. A person skilled in the art will recognize that current fuel cell transport layers are highly specialized for their particular roles, exhibiting ranges of pore sizes, morphological, and catalyst composition. The design of these porous diffusion electrodes can impact device performance as the diffusion electrodes fulfill several functionalities, such as transporting reactant gases to the catalytic sites, removal of electrochemically generated water, conducting electrons and heat, and/or cushioning mechanical compression of the stack.

The anisotropic and positionally-dependent microstructural features of the phase-separated electrode material 212 can eliminate the need for a multilayered arrangement. This can be achieved by facing the dense layer towards the membrane and the porous layer towards the flow fields. Introducing a catalytic layer 204 in between the membrane 202 and the electrode can enable reactions to occur. Depositing the catalytic layer 204 onto the dense region of the phase-separated electrode 212, which can act as a support, may enable fabrication of this electrode for use in fuel cells 200. It will be appreciated that reducing the number of components in the fuel cell 200 can help drive down manufacturing and production costs, and the orientation of the components of the fuel cell can be adjusted to match the needs for room temperature fuel cells in lieu of, or in addition to, the low temperature acidic fuel cell 200 of the present embodiments.

Example Performance Results

In this context of developing porous electrodes for RFBs, prepared materials have been characterized with microscopic and electrochemical techniques to elucidate their microstructural properties and performance metrics. The electrochemical active surface area, obtained with capacitance measurements under flow, can be about 3 m² g⁻¹ for the new materials as compared to about 0.2 m² g⁻¹ for the reference SGL 29AA electrode. In the present instances, neither sample was treated to, for example, increase surface area via thermal treatments in air or etching the surface to increase roughness.

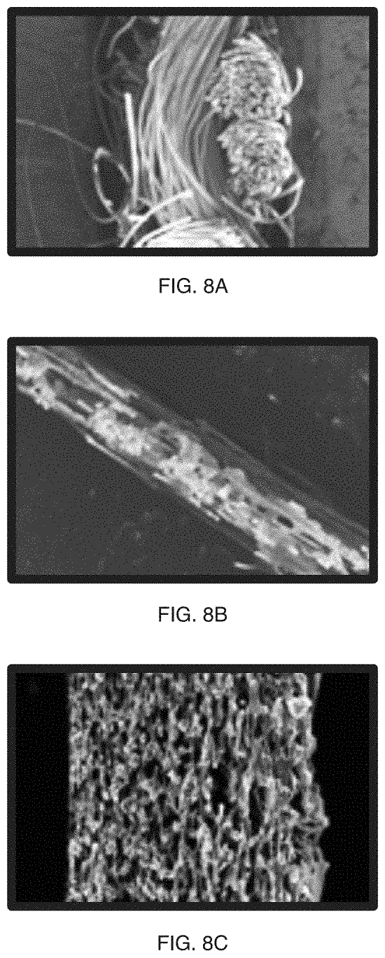

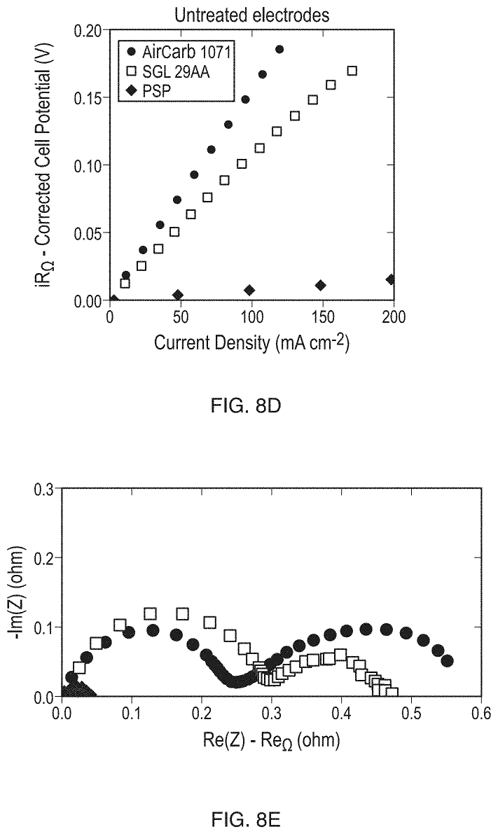

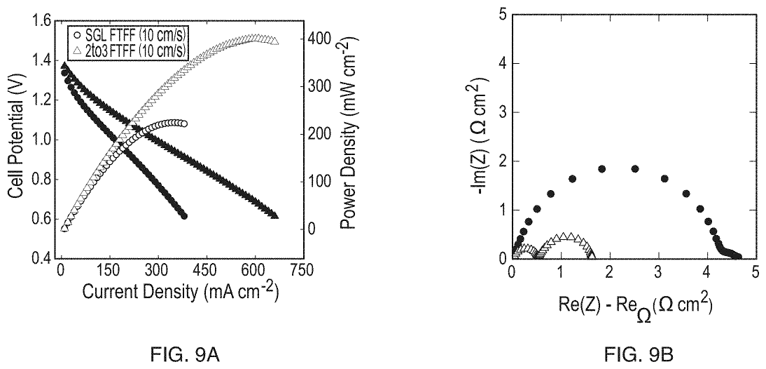

The prepared materials (2:3-PAN:PVP-ratio) were tested in two redox chemistries, namely the iron chloride redox couple in a single electrolyte flow cell, as shown in FIG. 8, and all-vanadium full cell, as shown in FIGS. 9A-9B. The polarization and impedance curves provided for in FIGS. 8D-8E show a significant performance improvement (i.e., lower overpotentials to achieve the same current density) as compared to reference commercial materials. More particularly, with respect to FIGS. 8A-8C, the performance of three electrodes is compared, namely a commercial woven electrode (AvCarb 1071), a commercial carbon paper (SGL 29AA), and an electrode prepared with the described art using a mass ratio of 2:3 for PAN:PVP. The scanning electron micrographs are shown on top. The three electrodes were compared based on their electrochemical performance in flow cells using a single electrolyte flow cell based on 0.5 M Fe^{2+/3+} (50% state of charge) in aqueous 2 M HCl, a membrane/separator such as Daramic 175 which can be used for iron tests, a 5 cm s⁻¹ electrolyte velocity, and flow through flow fields. The current-voltage curves (bottom left) and the electrochemical impedance spectroscopy (bottom right) show that the electrode prepared with the described art largely outperformed commercially materials, as shown by the lowest slope on the current-voltage curves and the lower resistance on the Nyquist plots. These differences may, at least in part, be driven by a reduction in kinetic and mass transport overpotentials and, thus, overall RFB efficiency is increased.

With respect to FIGS. 9A-9B, two materials, i.e., commercial SGL 29AA paper and an electrode prepared in view of the present disclosures, are compared in a full cell all-vanadium 1.5 M V (about 50% state of charge) in aqueous 2.6 M H₂SO₄, a Nafion 212 membrane, 10 cm s⁻¹, flow through flow field. In alternate embodiments, for example, for fuel cells, electrolyzers and/or redox flow batteries, flow field designs such as interdigitated flow field, serpentine flow field, parallel flow field, and/or flow through flow field can be used. The new electrode material can outperform the commercial electrode and features lower mass transfer and kinetic losses, thus increasing overall voltage efficiency. In other words, increasing the reactor power density can result in more compact reactor, which, in turn, results in materials cost reduction, or more power for the same reactor size. The samples illustrated in FIGS. 8A-8E and 9A-9B did not have any post-treatment applied to them, as they were tested as received.

Notably, the synthesized materials were prepared under a carbonization temperature of about 1050° C., which is significantly lower than that used to prepare state-of-the-art materials, which can be about 1800° C., or even higher, such as about 2500° C. The provides for the ability to control high temperature processes for increasing electrochemical performance, which can be beneficial because thermal process steps can be the largest contribution to manufacturing costs. See “Carbon felt and carbon fiber—A techno-economic assessment of felt electrodes for redox flow battery applications” by Minke et al, Journal of Power Sources, Volume 342, Feb. 28, 2017, pages 116-124.

Synthesis of NIPS Fabricated Porous Electrodes

In an alternative embodiment of synthesizing porous electrodes, formation of the membrane for the NIPS fabricated porous electrode, as discussed in FIG. 3A-3B, can include dissolving the PVP and DMF into the coagulation bath upon submersion, leaving behind a porous PAN framework. Subsequent thermal stabilization and carbonization of the polymer membrane can lead to the desired electrically conductive electrode. In these alternative embodiments, for example, sample can be made by mixing the following amounts of PAN and PVP in 10 mL of DMF: 1 g of PAN to 1 g PVP (1:1 PAN:PVP by mass), 0.857 g of PAN to 1.143 g PVP (3:4 PAN:PVP by mass), or 0.8 g of PAN to 1.2 g PVP (3:4 PAN:PVP by mass). The powder and solvent can be subsequently fully mixed after heating in a 70° C. oil bath. In some embodiments, an in-house glass mold for casting the mixed polymer solution can be constructed on an 18×18 cm² glass plate using 5×7 cm² notches having a depth of 1.1 mm. Once cooled to room temperature, the polymer solution can be poured in the notches, and the edge of a doctor blade can be used to evenly cast the solution into the glass notches. After 10 minutes at room temperature, the casted solution can be carefully immersed into a water bath (water level 6 cm above the casted solutions). Polymeric scaffolds can be set aside to phase separate overnight at room temperature, after which they were transferred into a deionized (DI) water (Milli-Q Millipore, 18.2 MΩ cm) bath and left overnight at 70° C. to remove the remaining PVP still present in the porous structure. Afterwards, the polymeric scaffolds can be dried between two paper sheets and placed between Teflon plates in an oven at 80° C. for >4 hours for drying. Each polymeric scaffold can be compressed with 0.399 cm thick, 5.1×10.8 cm² alumina ceramic blocks (McMaster-Carr) weighing 100 g on top of the Teflon plates.

Thermal stabilization of the PAN membranes can be conducted to crosslink the polymer network and improve the final mechanical properties of the electrodes. In some embodiments, membranes can be sandwiched between two sheets of alumina paper (Profiltra B.V.) and two ceramic plates. Each membrane can be compressed with 100-gram weights on top of the ceramic plates during thermal stabilization. Membranes can be thermally stabilized in air at 270° C. for 1 hour at a ramp rate of 2° C. min⁻¹. Directly following the thermal stabilization, membranes can be sandwiched by the ceramic plates and placed in a tubular oven under a nitrogen flow of 2 L min⁻¹. The membranes can then be exposed to a carbonization sequence, which included: room temperature to 850° C. (ramp rate of 5° C. min⁻¹), hold for 40 min, 850° C. to 1050° C. (ramp rate of 5° C. min⁻¹), hold for 40 min, cool down to room temperature. A person skilled in the art will recognize that and the above-mentioned alternative embodiment is a non-limiting example made possible by the present disclosures.

Commercial Applications

The disclosed techniques can be used to manufacture RFB electrodes tailored for specific cell chemistries. Electrodes fabricated by this method can likely be less expensive than currently carbon-fiber-bed electrodes. Further, the control of surface chemistry and microstructure afforded by the disclosed techniques can enable improvements in the device power density resulting in smaller reactor and system footprints (and thus reduced cost).

Beyond applications in the field of RFBs, the disclosed methodologies can have immediate impacts in other technologies, such as polymer electrolyte fuel cells, alkaline fuel cells, reversible fuel cells, phosphoric acid or high temperature fuel cells, metal-air batteries, CO₂/H₂O electrolyzers, and capacitive deionization, among others. Furthermore, electrocatalysts may be selectively added onto the polymer mixture to prepare heterogeneous electrodes with the added benefits coexisting carbonaceous, three-dimensional scaffolds, and/or decorating metallic particles.

Additional references that provide further information related to this disclosure include the following, each of which is incorporated by reference herein in its entirety:
K. J. Kim, M.-S. Park, Y.-J. Kim, J. H. Kim, S. X. Dou, M. Skyllas-Kazacos, J. Mater. Chem. A. 3 (2015) 16913-16933. doi:10.1039/C5TA02613J.
A. Forner-Cuenca, E. E. Penn, A. M. Oliveira, F. R. Brushett, J. Electrochem. Soc. 166 (2019) A2230-A2241. doi:10.1149/2.0611910jes.
A. Z. Weber, M. M. Mench, J. P. Meyers, P. N. Ross, J. T. Gostick, Q. Liu, J. Appl. Electrochem. 41 (2011) 1137. doi:10.1007/s10800-011-0348-2.

Examples of the above-described embodiments can include the following:
1. A method of fabricating a porous electrode, comprising:

exposing a polymer solution to a first solvent, the polymer solution comprising a first polymer and a second polymer; and

subsequently exposing the polymer solution to a second solvent, the second solvent being effective to induce phase inversion such that the first polymer of the polymer solution is separated from each of the second polymer of the polymer solution, the first solvent, and the second solvent, the first polymer being porous and forming a porous membrane.
2. The method of claim 1, further comprising:

performing one or more post-treatment actions to the porous membrane.
3. The method of claim 2, wherein the one or more post-treatment actions comprises crosslinking the porous membrane.
4. The method of claim 2 or claim 3, wherein the one or more post-treatment actions comprises one of carbonization of the porous membrane or graphitization of the porous membrane.
5. The method of any of claims 2 to 4, further comprising:

removing the porous membrane from the second solvent;

drying the porous membrane;

thermally stabilizing the porous membrane; and

one of carbonizing or graphitizing the porous membrane.
6. The method of any of claims 2 to 5, wherein the one or more post-treatment actions comprises configuring the porous first polymer into an electrode having a desired electrode configuration.
7. The method of claim 6, further comprising associating the electrode with a redox flow battery.
8. The method of any of claims 1 to 7, further comprising:

adjusting a temperature at which the action of subsequently exposing the polymer solution to a second solvent occurs.
9. The method of any of claims 1 to 8, wherein exposing a polymer solution to a first solvent occurs in a first bath, the first solvent being disposed in the first bath, and subsequently exposing the polymer solution to a second solvent occurs in a second bath, the second solvent being disposed in the second bath.
10. The method of claim 9, further comprising:

operating a roll-to-roll processing system to move the polymer solution from the first bath to the second bath;

operating the roll-to-roll processing system to move the first polymer from the second bath to another location; and

in instances in which the method further comprises performing one or more post-treatment actions to the porous first polymer when it is separated from each of the second polymer, the first solvent, and the second solvent, the another location being a location at which at least one post-treatment action of the one or more post-treatment actions is performed.
11. The method of any of claims 1 to 10, wherein exposing a polymer solution to a first solvent further comprises casting the combination of the polymer solution and the first solvent onto a glass mold.
12. The method of any of claims 1 to 11, wherein the first polymer is hydrophobic, the second polymer is hydrophilic, and the second solvent comprises water.
13. The method of any of claims 1 to 12, wherein exposing a polymer solution to a first solvent results in a skin layer of at least one of the first polymer and the second polymer to be removed.
14. The method of any of claims 1 to 13, wherein the first polymer after the phase inversion is substantially devoid of macrovoids.
15. The method of any of claims 1 to 14, wherein a pore size of the first polymer after the phase inversion is approximately in the range of about 0.5 nanometers to about 300 micrometers.
16. The method of any of claims 1 to 15, further comprising controlling a pore size of the first polymer that results from the phase inversion.
17. The method of claim 16, wherein controlling a pores size of the first polymer that results from the phase inversion comprises forming pore sizes in a first section of the first polymer and forming pore sizes in a second section of the first polymer, the pore sizes in the first section having different ranges that the pore sizes in the second section.
18. The method of claim 17, wherein the first section and the second section are differentiated from each other along a thickness of the first polymer.
19. The method of claim 17, wherein the first section and the second section are differentiated from each other along a length of the first polymer.
20. A polymer solution, comprising:

a first polymer having hydrophobic properties; and

a second polymer having hydrophilic properties,

wherein the first and second polymers are configured to form a polymer solution by mixing with a first solvent,

wherein the resulting polymer solution is configured to be separated into the first polymer and the second polymer by a second solvent via phase inversion, the second solvent including water such that the phase inversion results in the first polymer being separated from each of the second polymer, the first solvent, and the second solvent with the second polymer remaining with each of the first solvent and the second solvent.
21. The polymer solution of claim 20, wherein the first polymer comprises polyacrylonitrile.
22. The polymer solution of claim 20 or claim 21, wherein the second polymer comprises polyvinylpyrrolidone.
23. The polymer solution of any of claims 20 to 22, wherein a ratio of the first polymer to the second polymer is approximately 1:1.
24. The polymer solution of claim 23, wherein the first polymer comprises one gram of polyacrylonitrile and the second polymer comprises one gram of polyvinylpyrrolidone.
25. The polymer solution of any of claims 20 to 22, wherein a ratio of the first polymer to the second polymer is approximately 3:4.
26. The polymer solution of claim 25, wherein the first polymer comprises 0.857 grams of polyacrylonitrile and the second polymer comprises 1.143 grams of polyvinylpyrrolidone.
27. The polymer solution of any of claims 20 to 22, wherein a ratio of the first polymer to the second polymer is approximately 2:3.
28. The polymer solution of claim 27, wherein the first polymer comprises 0.8 grams of polyacrylonitrile and the second polymer comprises 1.2 grams of polyvinylpyrrolidone.
29. The polymer solution of any of claims 20 to 28, wherein a pore size distribution is tuned by changing a total solid content of the initial polymer solution in a range from about 16% to about 19% wt of the first and second polymers relative to the first solvent.
30. A porous membrane formation kit, comprising:

the polymer solution of any of claims 20 to 29;

a first solvent configured to mix with the first polymer and the second polymer to form the polymer solution; and

a second solvent configured to separate the first polymer from the second polymer via phase inversion, the second solvent comprising water.
31. The porous membrane formation kit of claim 30, wherein the first solvent comprises dimethylformamide.
32. The porous membrane formation kit of claim 31, wherein the first solvent comprises 10 mL of dimethylformamide.
33. A method of fabricating a redox flow battery, comprising:

exposing a polymer solution to a first solvent, the polymer solution comprising a first polymer and a second polymer; and

exposing the polymer solution to a second solvent to separate the first polymer from each of the second polymer of the polymer solution, the first solvent, and the second solvent, the first polymer being formed into a porous electrode.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

Some non-limiting claims that are supported by the contents of the present disclosure are provided below.

1. A method of fabricating a porous electrode, comprising:
exposing a polymer solution to a first solvent, the polymer solution comprising a first polymer and a second polymer; and
subsequently exposing the polymer solution to a second solvent, the second solvent being effective to induce phase inversion such that the first polymer of the polymer solution is separated from each of the second polymer of the polymer solution, the first solvent, and the second solvent, the first polymer being porous and forming a porous membrane.

2. The method of claim 1, further comprising:
performing one or more post-treatment actions to the porous membrane.

3. The method of claim 2, wherein the one or more post-treatment actions comprises crosslinking the porous membrane.

4. The method of claim 2, wherein the one or more post-treatment actions comprises one of carbonization of the porous membrane or graphitization of the porous membrane.

5. The method of claim 2, further comprising:
removing the porous membrane from the second solvent;
drying the porous membrane;
thermally stabilizing the porous membrane; and
one of carbonizing or graphitizing the porous membrane.

6. The method of claim 2, wherein the one or more post-treatment actions comprises configuring the porous first polymer into an electrode having a desired electrode configuration.

7. The method of claim 6, further comprising associating the electrode with a redox flow battery.

8. (canceled)

9. The method of claim 1, wherein exposing a polymer solution to a first solvent occurs in a first bath, the first solvent being disposed in the first bath, and subsequently exposing the polymer solution to a second solvent occurs in a second bath, the second solvent being disposed in the second bath.

10. The method of claim 9, further comprising:
operating a roll-to-roll processing system to move the polymer solution from the first bath to the second bath;
operating the roll-to-roll processing system to move the first polymer from the second bath to another location; and
in instances in which the method further comprises performing one or more post-treatment actions to the porous first polymer when it is separated from each of the second polymer, the first solvent, and the second solvent, the another location being a location at which at least one post-treatment action of the one or more post-treatment actions is performed.

11. The method of claim 1, wherein exposing a polymer solution to a first solvent further comprises casting the combination of the polymer solution and the first solvent onto a glass mold.

12. (canceled)

13. (canceled)

14. The method of claim 1, wherein the first polymer after the phase inversion is substantially devoid of macrovoids.

15. The method of claim 1, wherein a pore size of the first polymer after the phase inversion is approximately in the range of about 0.5 nanometers to about 300 micrometers.

16. The method of claim 1, further comprising controlling a pore size of the first polymer that results from the phase inversion.

17. The method of claim 16, wherein controlling a pores size of the first polymer that results from the phase inversion comprises forming pore sizes in a first section of the first polymer and forming pore sizes in a second section of the first polymer, the pore sizes in the first section having different ranges that the pore sizes in the second section.

18. (canceled)

19. (canceled)

20. A polymer solution, comprising:
a first polymer having hydrophobic properties; and
a second polymer having hydrophilic properties,
wherein the first and second polymers are configured to form a polymer solution by mixing with a first solvent,
wherein the resulting polymer solution is configured to be separated into the first polymer and the second polymer by a second solvent via phase inversion, the second solvent including water such that the phase inversion results in the first polymer being separated from each of the second polymer, the first solvent, and the second solvent with the second polymer remaining with each of the first solvent and the second solvent.

21. The polymer solution of claim 20, wherein the first polymer comprises polyacrylonitrile.

22. The polymer solution of claim 20, wherein the second polymer comprises polyvinylpyrrolidone.

23. (canceled)

24. The polymer solution of claim 23, wherein the first polymer comprises one gram of polyacrylonitrile and the second polymer comprises one gram of polyvinylpyrrolidone.

25-28. (canceled)

29. The polymer solution of claim 20, wherein a pore size distribution is tuned by changing a total solid content of the initial polymer solution in a range from about 16% to about 19% wt of the first and second polymers relative to the first solvent.

30-32. (canceled)

33. A method of fabricating a redox flow battery, comprising:
exposing a polymer solution to a first solvent, the polymer solution comprising a first polymer and a second polymer; and
exposing the polymer solution to a second solvent to separate the first polymer from each of the second polymer of the polymer solution, the first solvent, and the second solvent, the first polymer being formed into a porous electrode.
